(19) United States
(12) Patent Application Publication
(10) Pub. No.: US 2026/0001545 A1
(43) Pub. Date: Jan. 1, 2026

(54) AUTONOMOUS VEHICLE CONTROL IN COMPLEX DRIVING SITUATIONS

(71) Applicant: Torc Robotics, Inc., Blacksburg, VA (US)

(72) Inventors: Dimitrios Tzempetzis, Stuttgart, Baden-Württemberg (DE); Andre Scholich, Leipzig, Saxony (DE); Biswanath Behera, Stuttgart, Baden-Württemberg (DE); Bernd Reinhold, Stuttgart, Baden-Württemberg (DE)

(21) Appl. No.: 19/086,562

(22) Filed: Mar. 21, 2025

(30) Foreign Application Priority Data
Jun. 26, 2024 (DE) 102024118004.8

(51) Int. Cl. B60W 30/165; B60W 30/182; B60W 50/00; B60W 60/00; G06K 7/14

(52) U.S. Cl. CPC B60W 30/165; B60W 30/182; B60W 50/0097; B60W 60/0015; G06K 7/1417; B60W 2554/802; B60W 2556/40; B60W 2556/45

(57) ABSTRACT

A method for assisting an automated vehicle in vehicle control, the method including continuously checking whether the automated vehicle is leaving its operational design domain and whether a comparison metric of the deviation of current environmental conditions from the associated information on a digital map is exceeded. If so, the method further includes requesting an authorization to enter a vehicle-following mode at a control center; and rejecting the request or granting the request by the control center, wherein when the request is granted by the control center, a start of the vehicle-following mode and the road user to be followed are determined. The method additionally includes carrying out a vehicle-following mode by the vehicle at the start determined by the control center behind the road user determined by the control center.

### CROSS-REFERENCE TO RELATED APPLICATIONS

The present application claims priority to German Patent Application No. 102024118004.8 filed on Jun. 26, 2024, and titled “FOLLOW MODE FOR HIGHLY AUTOMATED VEHICLES IN ODD BOUNDARY AREAS AND SPECIAL SITUATIONS”, which is hereby incorporated by reference in its entirety.

### TECHNICAL FIELD

The present disclosure relates to a method for assisting a automated vehicle in guiding the vehicle through a challenging traffic area, as well as a system for assisting an automated vehicle in guiding the vehicle through a challenging traffic area.

### BACKGROUND

Automated driving in road traffic typically requires reliable perception of the environment using sensor systems. The greater the differences in a domain change from the training domain to the target domain, the more the quality and/or reliability of automated driving tends to degrade. Since situations at road construction sites can change frequently and at short notice, and the traffic routing there is often confusing and based on makeshift means, driving through such construction site areas is particularly challenging for an automated vehicle.

Lane guidance lines can be irregularly marked, have gaps and, in the case of glued lane markings, for example, have incorrect paths. Mapping such construction site areas is made difficult by frequent changes in traffic routing; new changes are often made within hours, for example in the case of lane narrowing.

This makes object classification by a machine learning model for the perception of the environment more difficult, which also makes it more difficult to localize oneself in relation to the environment, as well as to interpret traffic rules and ultimately also to plan the trajectory for one's own vehicle.

The development of SAE Level IV vehicles and higher is precisely aimed at eliminating the need for a human driver to provide control and to provide the same as a fallback option. An automatic driving control system must therefore be designed to be able to safely navigate through such challenging situations. In other words, the driving control system must be designed to handle as many possible scenarios as possible within a defined area to define an ODD (abbreviation for “operating design domain”). Typically, several different and redundant sensors are used for this purpose, as well as an accurate digital map for self-localization.

US 2022/0308583 A1 relates to a method for performing a vehicle assistance operation for an autonomous cargo vehicle, the method comprising: receiving sensor information from a perception system of the autonomous cargo vehicle by one or more processors; receiving real-time data from one or more devices of a parking facility by one or more processors; determining a trajectory to a parking space of the parking facility by one or more processors based on the sensor information of the perception system and the real-time data of the parking facility; and using the trajectory to enable a drive system of the autonomous cargo vehicle to drive to the parking space in an autonomous driving mode.

US 2020/0004269 A1 also relates to a travel assist device comprising: a vehicle-external information acquisition unit; a communication unit that communicates with a travel assistance management device and provides guidance vehicle information; and a control unit that executes subsequent travel control for traveling while following a leading vehicle indicated by leading vehicle information acquired by the travel assistance management device, wherein the subsequent travel control is performed using the external vehicle information acquired by the external vehicle information acquisition unit and the leading vehicle information.

JP 6973294 B2 relates to a vehicle search system consisting of a plurality of vehicles and a server device for searching for a vehicle to be searched for.

CN 204595513 U relates to an intelligent transportation fleet based on the following theory, wherein: including a following vehicle, the following vehicle is provided with an intelligent following system, the intelligent following system comprises: a controller, a wireless communication module, a vehicle identification module connected to the controller, and a speed drive module; the vehicle identification module comprises an image acquisition unit, an image processing unit, and a radio frequency identification unit for identifying the vehicle, the output end of the image acquisition unit being connected to the input end of the image processing unit, and the output end of the image processing unit being connected to the input end of the controller.

As explained at the beginning, large deviations between real data and the training data of a machine learning model can be problematic, and this model may not be able to produce valid results or may only be able to do so unreliably. This case occurs in particular when there are significant deviations between reality and the features of the digital map, or when the definition of the lane guidance cannot be clearly recognized, for example by lane markings. Then the limits of the operational design domain (this is the ODD described above) are reached or even exceeded, and safe driving of the automated vehicle may no longer be guaranteed.

If the vehicle is therefore brought into a safe state, such as a standstill, by the automatic driving control system using a safety maneuver, this may lead to traffic disruptions and the availability of the automated vehicle may be greatly reduced.

### BRIEF DESCRIPTION

The object of the invention is to enable the highly automated vehicle to safely navigate through such situations.

### BRIEF DESCRIPTION

A first aspect of the present disclosure relates to a method for controlling an automated vehicle through a challenging traffic area, the method comprising continuous checking of whether the automated vehicle is currently or in the future leaving its operational design domain during its journey in driver-less vehicle control, as well as whether a comparison metric of the deviation of current environmental conditions from the associated information on a digital map is exceeded. The method further comprising requesting an authorization to enter a vehicle-following mode at a control center if current or future departure from the operational design domain or exceedance of the comparison metric is detected, and rejecting the request or granting the request by the control center, wherein, if the request is granted by the control center, the start of the vehicle-following mode and the road user to follow are determined. The method additionally comprises performing a vehicle-following mode by the vehicle at the start determined by the control center behind the road user determined by the control center, wherein the vehicle-following mode merely comprises a following of the path of the preceding road user instead of an independent path planning for the vehicle.

In some embodiments, the automated vehicle is a truck. In particular, a fleet of trucks can be assigned to a common control center, which at least monitors the driver-less journeys of the trucks in organizational terms. For this purpose, the control center is advantageously provided with human personnel in order to be able to make decisions about the trucks' journeys at least remotely.

According to some embodiments of the present disclosure, the control center is also able to identify a suitable preceding road user who is suitable to serve as a following target for the following automated vehicle.

This procedure is applied when the vehicle is about to leave its predefined operational design domain, its ODD. This predefined operational design domain is determined in particular by the input data with which a machine learning model was trained in an automatic driving control system of the vehicle. This operating domain can also be left if the perception of the environment degrades too much due to sensors, for example due to bad weather conditions. Also in construction site areas, for example, when unclear road markings are specified, contradictory signs or similar situations prevail, the safe operating domain can no longer be maintained.

However, since fully automatic vehicle guidance also depends to a certain extent on the realism of digital maps, a digital map may not be up to date, particularly in construction site areas where lane guidance, narrowing and other conditions change rapidly. Even then, it can be difficult for the automated vehicle to localize itself and plan its path in order to ensure safe vehicle guidance. Critical situations can also arise when driving a truck as a private vehicle “Hub to Ramp” or “Ramp to Hub”, where pedestrians frequently participate in traffic and may be in the working area of the truck.

However, by following a preceding road user, one's own path planning can be discarded in favor of a simpler path following in relation to the preceding road user. The trajectory is carried out in a vehicle-following mode in which it is not necessary for the drivers to make their own decisions. A longitudinal distance control, which depends in particular on the current speed, ensures a safe distance from the following road user. In addition, a lateral control can be activated that follows the lateral guidance of the preceding road user, so that the automated vehicle substantially follows the same path as the preceding road user.

In some embodiments, the control center selects a suitable preceding road user based on the vehicle's own sensor data, although V2X signals from other road users can also be evaluated in order to determine, for example, the willingness to act as the target to be followed. In some embodiments, the speed and current distance of a respective other road user relative to their own vehicle are checked in order to determine suitability, since only other road users driving at a suitable speed and other road users in the vicinity of the own vehicle are considered. The suitability check may also take into account whether the other road user is following the same route as their own vehicle, at least in a certain section ahead, in order to prevent unwanted following it to the next exit, for example.

It is an advantageous effect of the present disclosure that particularly challenging traffic situations in which the automated vehicle leaves its operational design domain or is in danger of leaving it can still be navigated by the automated vehicle, while the risk of inappropriate path planning and thus the risk of accidents is reduced (e.g. practically eliminated).

According to an advantageous embodiment, the continuous checking of whether the automated vehicle leaves its operational design domain during its journey under driver-less vehicle control is carried out predictively.

The prediction of compliance with the operational design domain can be determined, for example, by classification probabilities or uncertainties. For example, if there are high levels of uncertainty in object recognition such as traffic sign recognition or lane marking recognition, there is no reliable basis for path planning for the vehicle with a sufficiently high level of safety. It may also be recorded in the database that a critical area such as a dynamic construction site is occurring on a section of the current route ahead, and therefore compliance with the operational design domain is questioned from the outset and the request is made to the control center long before this area is reached.

According to a further advantageous embodiment, the control center determines not only the start but also the end of the vehicle-following mode.

In general, the specified start time can also refer to a current point in time, namely the control center releases an immediate activation of a vehicle-following mode. In some embodiments, in addition to the fixed start, a duration is also set in advance, which can, however, also be defined in relation to a location and, for example, ends automatically when a construction site ends, after which the automated vehicle returns to independent trajectory planning.

According to a further advantageous embodiment, the control center transmits a registration number and/or a unique identification feature of the following road user that is not tied to the registration of the following road user but is unique, to the requesting automated vehicle, wherein the automated vehicle identifies the following road user by means of the registration number and/or the unique identification feature and an automatic driving control system of the vehicle carries out a vehicle-following mode with reference to the identified road user.

According to a further advantageous embodiment, the identification feature is a QR code.

In both cases, using the registration plate or another identification feature, the automated vehicle can clearly and quickly assign the vehicle to the desired preceding road user, that the automated vehicle should follow.

According to a further advantageous embodiment, the checking of whether the automated vehicle leaves its operational design domain during its journey under driver-less vehicle control and whether a comparison metric of the deviation of current environmental conditions from the associated information of a digital map is exceeded is carried out using sensors of the vehicle.

According to a further advantageous embodiment, the sensors of the vehicle comprise at least one of the following: LiDAR, RADAR, GNSS, camera, odometer, wheel speed sensor.

According to a further advantageous embodiment, the checking of whether the automated vehicle leaves its operational design domain during its journey under driver-less vehicle control is carried out with the aid of system states of an automatic driving control system of the vehicle, in particular in the machine learning model.

These system states can be derived from the latent representation of the environment; the system states can also be probabilities for a correct classification of objects in the vehicle's environment, a collision probability for a pre-planned trajectory, or similar.

According to a further advantageous embodiment, the vehicle-following mode comprises a longitudinal and lateral tracking of the preceding road user.

A further aspect of the present disclosure relates to a system for supporting an automated vehicle in guiding the vehicle through a challenging traffic area, comprising a control center and a control unit of the vehicle, wherein the control unit is designed to continuously check whether the vehicle leaves its operational design domain during its journey under driver-less vehicle guidance, as well as whether a comparison metric of the deviation of current environmental conditions from the associated information on a digital map is exceeded, and to request an authorization to enter a vehicle-following mode from a control center when leaving the operational design domain or exceeding the comparison metric is determined, wherein the control center is designed to reject or grant the request and, when granting the request, to determine a start of the vehicle-following mode and the road user to follow, wherein the vehicle is designed to carry out a vehicle-following mode at the start determined by the control center behind the road user determined by the control center, wherein the vehicle-following mode, instead of independent path planning for the vehicle, merely follows the path of the of the preceding road user.

Advantages developments of the proposed system result from an analogous and consistent transfer of the statements made above in connection with the proposed method.

### BRIEF DESCRIPTION OF DRAWINGS

Further advantages, features and details will be apparent from the following description, in which at least one exemplary embodiment is described in detail, with reference to the drawings where appropriate. The same, similar and/or functionally identical parts are provided with the same reference numerals.

FIG. 1 shows a method for assisting an automated vehicle in guiding the vehicle through a challenging traffic area according to an exemplary embodiment of the present disclosure.

FIG. 2 shows a situation in which a method according to FIG. 1 or a suitable system is applied.

### DETAILED DESCRIPTION

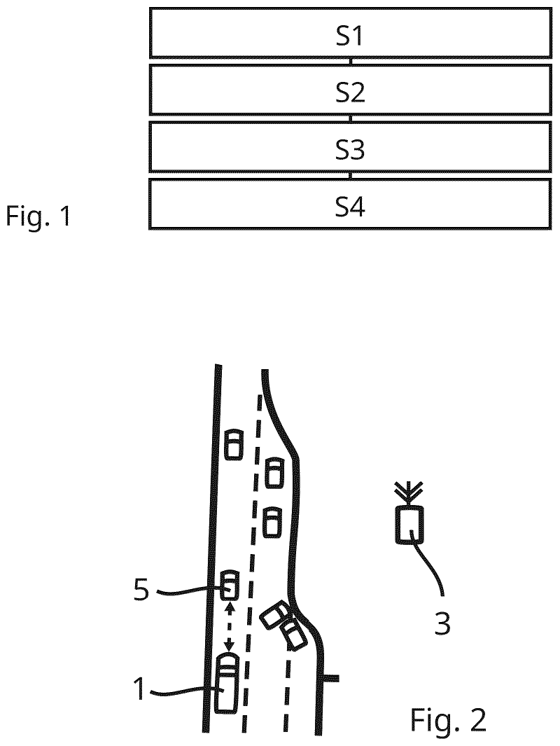

FIG. 1 shows a method for assisting an automated vehicle 1 in guiding the vehicle through a challenging traffic area, FIG. 2 shows an exemplary scenario in which the method of FIG. 1 is applied.

This example scenario shows a construction site area on a motorway. Due to the planned narrowing of the lanes due to the construction site, an accident occurred which oncoming vehicles have to avoid without any appropriate lane markings being provided. The automated vehicle 1 under consideration is a truck, however, other vehicle types are appreciated without departing from the spirit/scope of this disclosure. The method for assisting this truck in such challenging situations, which cannot be handled or can only be handled with difficulty by its automatic driving control system, requires that a continuous and ongoing check S1 is carried out to determine whether the automated vehicle 1 leaves its operational design domain during its journey under driver-less vehicle control, and whether a comparison metric of the deviation of current environmental conditions from the associated information of a digital map is exceeded. Larger deviations of the digital map from reality can lead to incorrect execution of the automatic driving control system, as in the example scenario where lanes marked on the digital map are currently not passable due to construction work, and there are additional obstacles on the already makeshift lanes that also have to be avoided. This presents a complex scenario in which finding a solution for the automatic driving control system can become difficult. In this case, the driving control system recognizes that the detection of the environment is not working correctly and that the path planning is carried out with corresponding uncertainty. If this is the case, namely if it is determined that the operational design domain has been left or that the comparison metric has been exceeded, the automatic driving control system of the truck 1 requests S2 an authorization to enter a vehicle follow mode at a control center 3. The control center 3 is a stationary unit which is connected to the at least one automated vehicle 1 via a wireless communication link. Using all the information available to control center 3, control center 3 now decides whether another road user 5 is present who could be used as a target for automatic tracking. In the present example, there is a passenger car that is driving ahead of truck 1 at an appropriate distance and at the same speed. The control center 3 therefore authorizes S3 the truck 1 to enter an automatic vehicle-following mode, namely the truck 1 carries out a distance regulation relative to the passenger car 5 in order to maintain a speed-dependent target distance to the latter and to follow the path of the road user 5. The identification of the specific additional road user 5 is carried out by transferring the registration number of the road user 5 to the automated truck 1. The truck 1 can thus identify the specific road user 5 and carry out the longitudinal control and the lateral control by detecting the additional road user 5 S4.

Although the present disclosure has been further illustrated and described in detail by way of exemplary embodiments, the present disclosure is not limited by the disclosed examples, and other variations can be derived therefrom by those skilled in the art without departing from the scope of the present disclosure. It is therefore clear that various possible variations exists. It is also clear that exemplified embodiments are really only examples, which are not to be construed in any way as limiting the scope, applicability, or configuration of the present disclosure. Rather, the foregoing description and description of the figures enable one skilled in the art to concretely implement the exemplary embodiments, wherein the skilled in the art, with the knowledge of the disclosed inventive concept may make various changes, for example as to the function or arrangement of individual elements cited in an exemplary embodiment, without departing from the scope as defined by the claims and their legal equivalents, such as more extensive explanations in the description.

1. A method for controlling an automated vehicle through a traffic area using a control unit of the vehicle, the method comprising:
checking whether the automated vehicle is leaving an operational design domain during a journey under autonomous control;
checking whether a comparison metric of a deviation of current environmental conditions from associated information on a digital map is exceeded;
requesting, from a control center, an authorization to enter a vehicle-following mode if departure from the operational design domain or exceedance of the comparison metric is determined;
initiating the vehicle-following mode and determining a road user to follow, if the request is granted by the control center, wherein the control center is configured to reject or grant the request; and
performing the vehicle-following mode behind the road user determined by the control center at a start point determined by the control center, wherein the vehicle-following mode comprises following of a path of the road user.

2. The method according to claim 1,
wherein the checking of whether the automated vehicle leaves the operational design domain during the journey under autonomous control is carried out predictively.

3. The method according to claim 1, the method further comprising determining, via the control center, an end of the vehicle-following mode.

4. The method according to claim 1, the method further comprising
receiving, from the control center, an identifier of the road user, wherein the automated vehicle identifies the road user using the identifier and an automatic driving control system of the vehicle carries out the vehicle-following mode with reference to the road user.

5. The method according to claim 4,
wherein the identifier is selected from the group consisting of a quick-response (OR) code, a unique registration number, and combinations thereof.

6. The method according to claim 1,
wherein the checking of whether the automated vehicle leaves the operational design domain during the journey under autonomous control and whether a comparison metric of the deviation of current environmental conditions from the associated information of a digital map is exceeded is carried out using at least one sensor of the vehicle.

7. The method according to claim 6,
wherein the at least one sensor of the vehicle is selected from the group consisting of LiDAR, RADAR, GNSS, odometer, camera, wheel speed sensor, and combinations thereof.

8. The method according to claim 1,
wherein the checking of whether the highly automated vehicle leaves the operational design domain during the journey under autonomous control is carried out using system states of an automatic driving control system of the vehicle.

9. The method according to claim 1,
wherein the vehicle-following mode comprises longitudinal and lateral tracking of the road user.

10. A system configured to control an automated vehicle through a traffic area, the system comprising:
a control center; and
a control unit of the vehicle, wherein the control unit is configured to:
check whether the vehicle leaves an operational design domain during a journey under driver autonomous control,
check whether a comparison metric of the deviation of current environmental conditions from the associated information on a digital map is exceeded, and
request an authorization to enter a vehicle-following mode from a control center when leaving the operational design domain or exceeding the comparison metric, wherein the control center is configured to:
reject or grant the request, and
when granting the request, to determine a start of the vehicle-following mode and a road user to follow.

11. The method according to claim 8, wherein the checking of whether the automated vehicle leaves the operational design domain during the journey under autonomous control utilizes a machine learning model.

12. The system of claim 10, wherein the automated vehicle comprises at least one sensor.

13. The system of claim 12, wherein the at least one sensor is selected from a group consisting of LiDAR, RADAR, GNSS, odometer, camera, wheel speed sensor, and combinations thereof.

14. The system of claim 10, wherein the automated vehicle comprises a wireless communication link which is configured to communicate with the control center.

15. The system of claim 10, wherein the control unit is configured to determine a speed-dependent target distance between the automated vehicle and the road user.

16. The method of claim 1, further comprising determining a speed-dependent target distance between the automated vehicle and the road user.

17. The method of claim 1, wherein the traffic area is a construction zone.

18. The system of claim 10, wherein the traffic area is a construction zone.

19. The system of claim 10, wherein the vehicle is configured to carry out a vehicle-following mode, behind the road user determined by the control center, at the start determined by the control center, and
wherein the vehicle-following mode comprises following the path of the road user.
